(19) United States
(12) Patent Application Publication
(10) Pub. No.: US 2026/0189583 A1
(43) Pub. Date: Jul. 2, 2026

(54) SYSTEM AND METHOD FOR PROACTIVELY ENRICHING A REPUTATION DATABASE OF BAD CYBER ACTORS BASED ON SIMILARITY SCORES FOR BAD ACTORS’ BEHAVIOR PROFILES

(71) Applicant: Radware Ltd., Tel Aviv (IL)

(72) Inventor: Guy PEREZ, Yavne (IL)

(73) Assignee: Radware Ltd., Tel Aviv (IL)

(21) Appl. No.: 19/006,773

(22) Filed: Dec. 31, 2024

(51) Int. Cl. H04L 9/40; G06F 16/23

(52) U.S. Cl. CPC H04L 63/1425; G06F 16/23

(57) ABSTRACT

A system and method for enriching a reputation database is provided. The system and method comprise: receiving attack attributes associated with an attack campaign; extracting an attack behavior profile for an identity linked to the attack campaign, wherein the attack behavior profile is based on the received attack attributes; retrieving, from a reputation database, behavior profiles of known bad actor groups, wherein bad actor groups are collections of network identities identified for engaging in malicious cyber activity; determining similarity scores between the extracted attack behavior profile and the behavior profiles of each known bad actor group; and enriching the reputation database by updating, based on the determined similarity scores, the extracted attack behavior profile and the behavior profiles of known bad actor groups stored in the reputation database.

### TECHNICAL FIELD

The present disclosure relates generally to techniques for enriching cyber security reputation services.

### BACKGROUND

Correlating and associating malicious cyber activity patterns with known malicious cyber actor groups involves analyzing various indicators such as origin subnets, origin location, involved TLS fingerprints, attack tactics and techniques, attack tools (software) and other attack parameters. In some cases, these indicators are compared against known data from third-party reputation data sources, to identify potential matches with known malicious entities (or actors), and mitigate the attack by blocking traffic originated by the bad actors'identities. The matching against the reputation database services can be based on IP addresses and other identity parameters associated with bad reputation scores.

One significant problem with current approaches of maintaining and extending lists of actors with bad reputations is the heavy reliance on manual analysis by humans. This manual process is time-consuming and resource-intensive, requiring substantial effort to analyze and correlate data. Additionally, human analysis can be subjective, leading to inconsistencies and potential biases. This reliance on manual processes makes the approach reactive, as it takes time for analysts to analyze and update the reputation lists in time, leaving the networks vulnerable i.e., a higher rate of false negatives, where an attack campaign is not identified as being associated with a known bad actor group, and false positives, where an attack campaign is incorrectly identified as being associated with a known bad actor group. The result is an increased Mean Time to Resolution (MTTR), as more time is needed to accurately identify and respond to threats. This delay can have serious implications for the security and integrity of affected systems.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for enriching a reputation database. The method comprises: receiving attack attributes associated with an attack campaign; extracting an attack behavior profile for an identity linked to the attack campaign, wherein the attack behavior profile is based on the received attack attributes; retrieving, from a reputation database, behavior profiles of known bad actor groups, wherein bad actor groups are collections of network identities identified for engaging in malicious cyber activity; determining similarity scores between the extracted attack behavior profile and the behavior profiles of each known bad actor group; and enriching the reputation database by updating, based on the determined similarity scores, the extracted attack behavior profile and the behavior profiles of known bad actor groups stored in the reputation database.

Certain embodiments disclosed herein also include a non-transitory computer readable medium having stored thereon causing a processing circuitry to execute a process, the process comprising: receiving attack attributes associated with an attack campaign; extracting an attack behavior profile for an identity linked to the attack campaign, wherein the attack behavior profile is based on the received attack attributes; retrieving, from a reputation database, behavior profiles of known bad actor groups, wherein bad actor groups are collections of network identities identified for engaging in malicious cyber activity; determining similarity scores between the extracted attack behavior profile and the behavior profiles of each known bad actor group; and enriching the reputation database by updating, based on the determined similarity scores, the extracted attack behavior profile and the behavior profiles of known bad actor groups stored in the reputation database.

Certain embodiments disclosed herein also include a system for enriching a reputation database. The system comprises: a processing circuitry; and a memory, the memory containing instructions that, when executed by the processing circuitry, configure the system to: receive attack attributes associated with an attack campaign; extract an attack behavior profile for an identity linked to the attack campaign, wherein the attack behavior profile is based on the received attack attributes; retrieve, from a reputation database, behavior profiles of known bad actor groups, wherein bad actor groups are collections of network identities identified for engaging in malicious cyber activity; determine similarity scores between the extracted attack behavior profile and the behavior profiles of each known bad actor group; and enrich the reputation database by updating, based on the determined similarity scores, the extracted attack behavior profile and the behavior profiles of known bad actor groups stored in the reputation database.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flow diagram illustrating a method for enriching a reputation database with new bad reputation identities based on determined similarity scores according to an embodiment.

FIG. 3 is a flowchart illustrating a method for proactively enriching behavior profiles in a reputation database based on similarity scores determined between attack behavior profiles and behavior profiles of known bad actor groups according to an embodiment.

FIG. 4 is a flowchart illustrating a method for enriching the reputation database when the attributes associated with an attack campaign are received through the use of a behavior detection method according to an embodiment.

FIG. 5 is a flowchart illustrating a method for enriching the reputation database when the attributes associated with an attack campaign are received through the use of a reputation-based detection method according to an embodiment.

FIG. 6 is a schematic diagram of a system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for enriching the cyber behavior profiles (hereinafter behavior profiles or profiles) of known malicious cyber actor groups (hereinafter bad actor groups or bad actors) and generating profiles for groups that were previously unknown. The various disclosed embodiments include a system and method for determining whether, based on calculating similarity scores between a newly-detected actor associated with a cyber-attack campaign (hereinafter attack campaign) and all known bad actor groups, the newly-detected bad actor belongs to a particular known bad actor group or belongs to a previously unknown bad actor group and should have a new group profile generated.

The system and method are configured to detect attack campaigns by analyzing attributes of network traffic and logs using various techniques including behavior-based methods and reputation-based methods. The disclosed embodiments include extracting behavior profiles for identities linked to the attack campaign based on behavioral indicators of the attack campaign. In an example embodiment, the method includes computing similarity scores by evaluating similarity metrics between the extracted behavior profiles and the profiles of the known bad actor groups. Based on what category the similarity score is in i.e., how similar the profiles are, the system and method may extend the profile of a known bad actor group by adding behavioral and identity parameters of the extracted behavior profile, generating new group profiles, de-linking (and re-matching) identities with bad actor groups, and updating various parameters in the profiles. The profiles of known bad actors are stored in a reputation database and the profiles generated by the system and method are also stored in a reputation database. Enriching the profiles and generating new ones in the reputation database is performed by the system and method according to various embodiments.

By extracting behavior profiles and determining similarity scores between the extracted profiles and the profiles of known bad actor groups, the disclosed embodiments allow for the proactive enrichment of the behavior profiles in the reputation database more accurately and efficiently. The accurate and efficient updating of the profiles and generation of new profiles enables more efficient detection and mitigation of new attack campaigns that may be linked to known bad actor groups.

Additionally, the proactive enrichment of the reputation database according to the various disclosed embodiments serves to reduce the inaccurate profiling of network identities engaged in malicious cyber activity. This allows such network identities to be associated with the profile that has the highest similarity score for the identity. It also allows for the generation of new profiles for identities that do not have a sufficiently high similarity score with known bad actor group profiles. This flexible, proactive approach to enriching a reputation database based on the determined similarity scores ensures that new attack campaigns can be accurately attributed to the correct bad actor group or attributed to a new group if there are no strong associations with known bad actor groups.

Further, the improvements associated with the various disclosed embodiments enable faster, more accurate detection of attacks than is possible through traditional methods, which yields a lower false positive rate of detections. Additionally, the improvements disclosed herein enable mitigation such as, but not limited to, generating a notification, blocking at least a portion of the network traffic, and the like before detrimental damage is made to an entity.

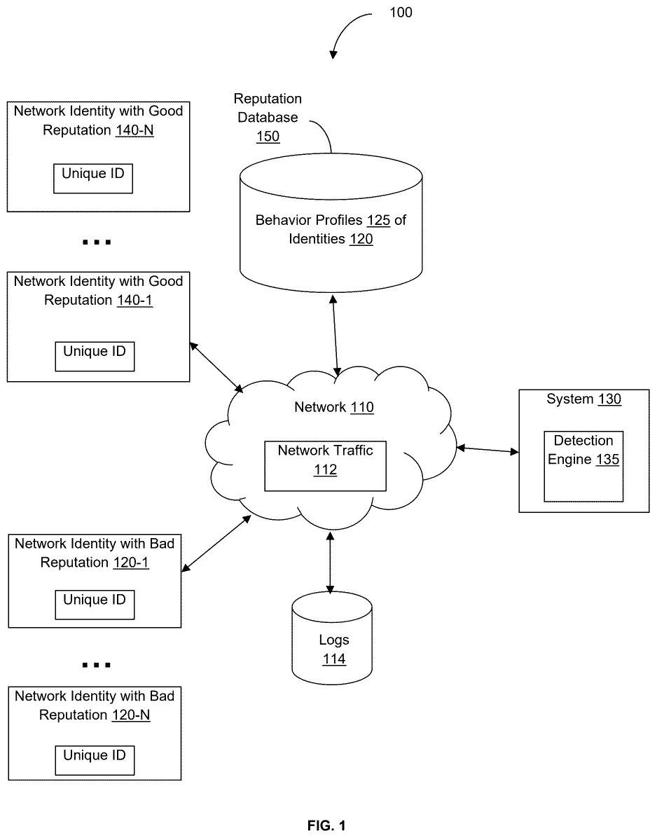

FIG. 1 is an example network diagram 100 utilized to describe the various disclosed embodiments. In the example network diagram 100, network identities with bad reputation 120-1 through 120-N (hereinafter referred to individually as identity 120 and collectively as identities 120, merely for simplicity purposes, where N is an integer greater than 1), network identities with good reputation 140-1 through 140-N (hereinafter referred to individually as identity 140 and collectively as identities 140, merely for simplicity purposes, where N is an integer greater than 1), logs 114, system 130, and a reputation database 150 are connected via a network 110.

The network may be, but is not limited to, a wireless, cellular, or wired network, a local area network (LAN), a wide area network (WAN), a metro area network (MAN), the Internet, the world wide web (WWW), similar networks, and any combination thereof. The identities 120 and identities 140 communicate over the network 110, resulting in network traffic 112 on the network 110. Logs 114 are a stored record of events that occur within the network 110 and other computer systems. Logs 114 are typically stored on servers to provide a centralized and secure location for storing, monitoring, and analyzing such critical data.

Based on the attributes of the network traffic 112 generated by both identities 120 and identities 140 as well as the attributes of the logs 114, the system 130 is configured to detect an attack campaign. Network traffic 112 is defined as a data communicated over the network 110.

The system 130 includes a detection engine 135 configured to detect attack campaigns. In various embodiments, attack campaigns may be detected through the use of, but not limited to, behavior-based methods or reputation-based methods. Attack campaigns may be linked to identities 120 or identities 140 through the association of indicators of the attack campaign with a unique ID for each identity 120 and identity 140.

The system 130 retrieves the behavior profiles 125 of known network identities 120 and identities 140 that are stored in reputation database 150.

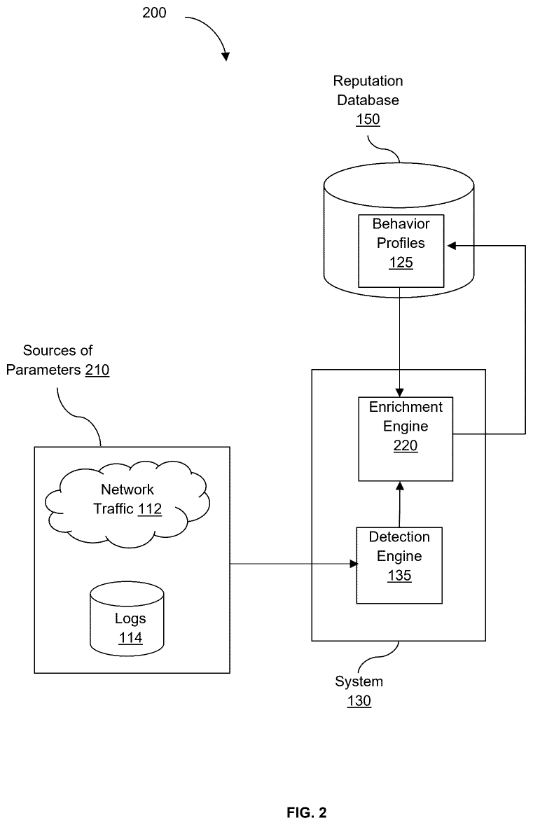

Behavior profiles 125 include parameters such as, but not limited to, a profile name, unique profile ID associated with each identity 120, a group-profile score, behavioral parameters, relations parameters, reputation score associated with each identity 120, identity-profile scores, and metadata. These parameters are defined and discussed in more detail hereinbelow with respect to FIGS. 2, 210.

The system 130 also includes an enrichment engine 220 (not shown) discussed in more detail with respect to FIG. 2. The enrichment engine 220 is configured to receive, from the detection engine 135, parameters relevant to an ongoing attack behavior profile and the associated identities generating them. Additionally, it retrieves existing attack behavior profiles 125 (known actor groups'attack profiles) from the reputation database 150 and proactively enriches them with the identities associated with the ongoing attack if the ongoing attack behavior profile is similar to one of the existing bad actor behavior profiles 125. This enrichment is based on similarity scores computed by the enrichment engine.

A reputation database 150 is a specialized repository of information used to evaluate and classify the trustworthiness or risk level of entities in a specific domain, most commonly in the context of cybersecurity. It contains data about entities like IP addresses, domain names, URLs, email addresses, applications, or devices, along with associated reputation scores or categorizations. An entity designated in the database 150 is assigned a score. The score in a reputation database is a numerical or categorical value that reflects the trustworthiness or risk level of a particular entity, such as an IP address, domain, URL, email address, or file. The score helps users or automated systems quickly assess whether the entity is safe, suspicious, or malicious and take appropriate actions. The score usually ranges from 0 to 100, −10 to +10, or another scale, depending on the service. For example, 0-20: High risk (malicious), 21-50: Medium risk (suspicious), and 51-100: Low risk (safe). Each entity is associated with a structured behavioral profile, which may include an IP address, users, one or more subnets, one or more domains, one or more TLS fingerprints, and the like.

The reputation database 150 is typically provided by a reputation databases are provided third-party services. Examples of such services include VirusTotal, Spamhaus, and the like.

According to the disclosed embodiments, the reputation database 150 is enriched by correlating malicious activity patterns with a known group of entities recognized as malicious in the database 150 and extending these groups with new entities. The group of entities recognized as malicious will be referred to as “bad actors” and entities are referred to as identities.

The reputation database 150 is a repository for storing the attack behavior profiles 125 of identities 120 and reputation scores associated with each identity 120.

In an embodiment, the system 130 enriches the behavior profiles 125 in the reputation database 150 by generating, updating, and storing the behavior profiles 125 of identities 120. The system 130 is configured to identify behavior parameters and identity parameters, as listed and defined below with respect to FIG. 2, based on the attributes of the network traffic 112 and logs 114 associated with an attack campaign to extract attack behavior profiles of identities 120 and/or identities 140 that are linked to an attack campaign. The system 130 is configured to compute similarity scores between the extracted attack behavior profile associated with the identity attributed to the attack campaign and the behavior profiles 125 of known identities 120. Based on these determined similarity scores, the system 130 enriches the behavior profiles 125. The enrichment based on the determined similarity scores is discussed in more detail below.

It should be understood that the embodiments disclosed herein are not limited to the specific architecture illustrated in FIG. 1, and other architectures may be equally used without departing from the scope of the disclosed embodiments. Specifically, the system 130 may reside in a cloud computing platform, a data center, and the like. Moreover, in an embodiment, there may be a plurality of servers operating as described hereinabove and configured to either have one as a standby, to share the load between them, or to split the functions between them.

FIG. 2 is an example flow diagram 200 illustrating a process for enriching the reputation database based on determined similarity scores according to an embodiment.

The detection engine 135 of the system 130 is configured to identify attack campaigns by monitoring logs 114 and network traffic 112. Parameters of attack campaigns are received, by an enrichment engine 220, from sources of parameters 210. Sources of parameters 210 include parameters listed with respect to FIGS. 1, 125. Sources of parameters 210 may include sources of information of an attack campaign. This information may be detected at the data link layer, network layer, transport layer, session layer, presentation layer, and application layer of a communication or computer system. Parameters of attack campaigns are received from the sources of parameters 210 by the enrichment engine 220 of the system 130. The enrichment engine 220 is configured to receive information about the attack campaign from the detection engine 135 and extract behavior profiles 125 based on the parameters received from the sources of parameters 210. The functions of the enrichment engine 220 are discussed in more detail herein.

Behavioral parameters include, but are not limited to, techniques, tactics and procedures (TTPs) i.e., attack vectors, used in the attack campaign; indicators of attack (IOAs); indicators of compromise (IOCs); attack tools (software) etc. Additionally, it includes target verticals; target services; target platforms; target companies; communication methods; attack origin; and Transport Layer Security (TLS) fingerprints. TTPs include, but are not limited to, spear phishing, denial of service (DoS) and distributed denial-of-service (DDoS), brute force, encryption for impact, and credential stuffing. In some embodiments, TTPs are extracted by behavioral and data packet inspection and analysis, which are mapped to TTPs stored in knowledge bases. IOAs and IOCs are observable behaviors e.g., malicious files and URLs, and artifacts linked to attacks. In some embodiments, IOAs and IOCs are extracted by, for example, IOC monitoring systems and correlation engines, using threat intelligence feeds and historical analysis.

Target verticals are sectors targeted by an attack, which are extracted by, for example, historical and real-time traffic patterns, domain analysis, or threat intelligence feeds using tools such as, but not limited to, log parsing and network monitoring tools. Target services are specific services targeted by the attack e.g., databases, web servers, streaming, chat, etc., which are extracted through network service analysis and log analysis using, for example, service recognition tools. Target companies may include, but are not limited to, banks, cloud computing companies, and information systems providers. Target platforms may include, but are not limited to, operating systems, cloud service providers, etc.

Communication protocols that are used to carry the attack include, but are not limited to, Hypertext Transfer Protocol (HTTP), and Domain Name Service (DNS), extracted through, for example, packet inspection and correlation of communication patterns using tools such as, but not limited to, network protocol analyzers and network logs. Attack origin is defined as the attack source measured by, for example, geolocation, IP address ranges, and Autonomous System Numbers (ASNs) extracted by IP lookups, real-time traffic, or historical threat data using tools such as, but not limited, to IP reputation databases and ASN tools. TLS fingerprints are defined as unique identifiers, such as, but not limited to, cipher suites and certificates, observed from a TLS handshake extracted by analyzing the TLS handshake and correlating the handshake with known patterns using TLS fingerprinting tools.

Relation parameters include, but are not limited to, relations to bad actor groups, attack tools e.g., software; and attack groups (activity clusters that are tracked by a common name). A group-profile score is defined as a measurement based on the size of the group i.e., the number of identities associated with the group (identities originating the bad behavior), and each identity's identity-profile score. An identity-profile score is defined as a measurement of how closely an identity matches i.e., belongs to, the profile for a particular group. A reputation score is a numerical score representing the threat level of the identity.

The enrichment engine 220 is configured to determine or otherwise derive behavior profiles 125 based on behavioral parameters and identity parameters of attack campaigns, retrieve behavior profiles 125 from the reputation database 150, and calculate similarity scores between the extracted attack behavior profile and the known behavior profiles 125 stored in the reputation database. The enrichment engine 220 is configured to enrich the behavior profiles 125, generate new behavior profiles 125, link new identities to an existing profile, or re-assign (de-link) an identity from one group to another, in the reputation database 150 based on the similarity score determined with respect to the two behavior profiles 125 compared.

The engines 220 and 135 may be realized in software, hardware, firmware, or a combination thereof.

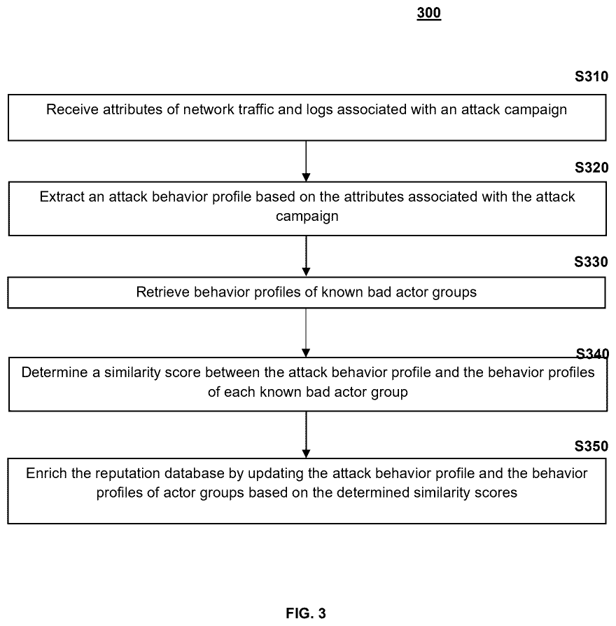

FIG. 3 is a flowchart of an example process 300 for proactively enriching behavior profiles in a reputation database based on similarity scores determined between attack behavior profiles and behavior profiles of known bad actor groups according to an embodiment. In some embodiments, one or more process blocks of FIG. 3 may be performed by system 130. For example, system 130 may update, in the reputation database 150, the attack behavior profile and the behavior profiles of actor groups based on the similarity scores that the system 130 computes.

At S310, attributes of network traffic data and logs associated with an attack campaign are received. In an embodiment, the real-time monitoring of logs and network traffic uses tools such as Network Traffic Analysis (NTA), User and Entity Behavior Analytics (UEBA), and Incident Detection and Response (IDR), but monitoring is not limited to such tools. In an embodiment, attributes of network traffic and logs are behavioral anomalies detected in the network traffic and logs associated with an identity. In an embodiment, attributes associated with an attack campaign may be received through a behavioral detection method or a reputation-based detection method but are not limited to such methods. In an embodiment, the attributes associated with the attack campaign are received by the detection engine 135.

At S320, an attack behavior profile is extracted. The attack behavior profile is extracted based on the attributes associated with the attack campaign. In an embodiment, the enrichment engine 220 of the system 130 extracts the attack behavior profile by constructing a profile that includes behavioral and identity parameters received by the detection engine 135 as explained above.

At S330, behavior profiles of known bad actor groups are retrieved. In an embodiment, the behavior profiles of known bad actor groups are stored in the reputation database 150 and are retrieved by the enrichment engine 220 and the system 130.

At S340, a similarity score is computed. In an embodiment, the similarity score is computed between the attack behavior profile and the behavior profiles of each known bad actor group. The similarity score is defined as a measurement of similarity between behavior profiles. In some embodiments, the similarity score between the attack behavior profile of an identity and a profile of a known bad actor group is an identity-profile score as defined above. In various embodiments, the similarity score and the identity-profile score may be used interchangeably.

In an embodiment, the similarity score is computed by measuring Euclidean distance between the behavior profiles. This embodiment may include measuring the absolute difference in numerical parameters of the compared profiles such as, but not limited to, attack frequency. In various embodiments, this approach is useful for comparing activity volumes or timelines.

In an embodiment, the similarity score is computed by cosine similarity. This embodiment may include measuring the similarity of categorical data vectors that represent parameters such as, but not limited to, attack vectors, attack techniques, attack tactics, or communication protocols.

In an example embodiment, the similarity score is computed by Jaccard similarity. This approach includes measuring the overlap between two sets of parameters in the behavior profiles. In various embodiments, this approach is used to calculate similarity between parameters including, but not limited to, common IOAs/IOCs and common attack tools.

The various disclosed embodiments include the use of each approach for calculating similarity scores separately or in various combinations.

At S350, the reputation database is enriched. In an embodiment, enriching the reputation database is achieved by updating the extracted attack behavior profile and the behavior profiles of known identities i.e. known actor groups stored in the reputation database.

The types of updates made to the reputation database depend on the category into which the computed similarity score belongs. In some embodiments, there are three categories of similarity: low, medium and high. In other embodiments, there are two categories of similarity: low and high.

Category of low similarity means that the computed similarity score falls into a range that is pre-determined to be a low. This means that there is minimal overlap between the extracted attack behavior profile and the behavior profile of the known bad actor group to which the attack behavior profile is compared.

Category of medium similarity means that the computed similarity score falls into a range that is pre-determined to be medium. This means that there is partial overlap between the extracted attack behavior profile and the behavior profile of the known bad actor group to which the attack behavior profile is compared.

Category of high similarity means that the computed similarity score falls into a range that is pre-determined to be high. This means that there is strong overlap between the extracted attack behavior profile and the behavior profile of the known bad actor group to which the attack behavior profile is compared.

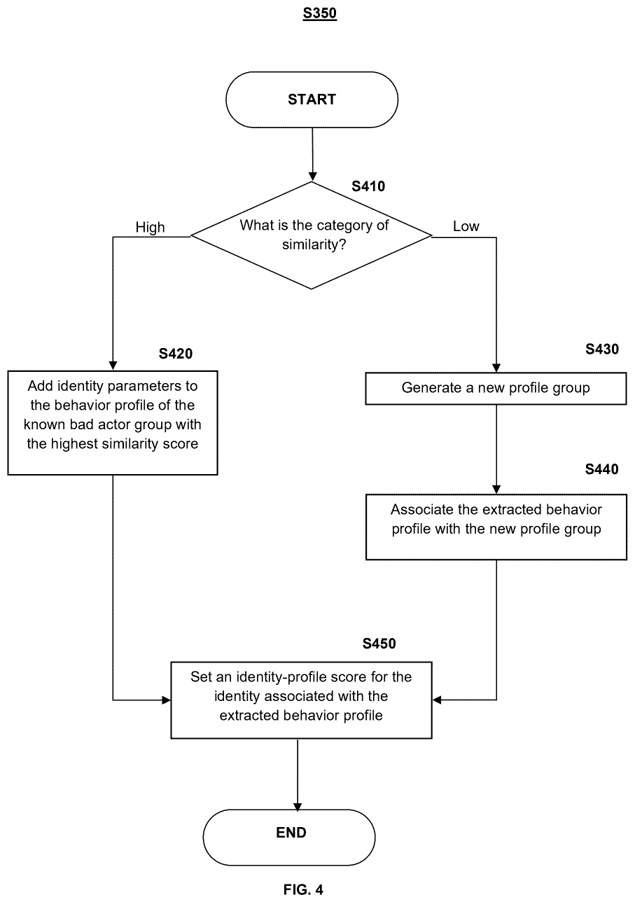

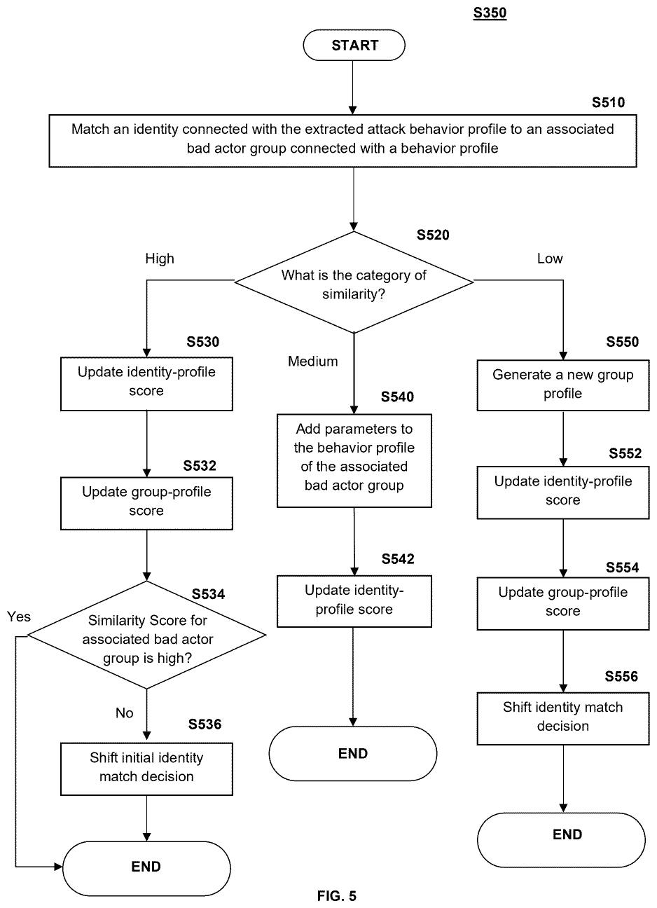

The types of updates to the reputation database based on the category of similarity is discussed in further detail hereinbelow with respect to FIGS. 4 and 5.

Although FIG. 3 shows example blocks of process 300, in some embodiments, process 300 may include additional blocks, fewer blocks, different blocks, or differently arranged blocks than those depicted in FIG. 3. Additionally, or alternatively, two or more of the blocks of process 300 may be performed in parallel.

FIG. 4 is a flowchart of an example process S350 for enriching the reputation database according to one embodiment. Process S350 is implemented when the attributes associated with an attack campaign are received through the use of a behavior detection method. In some embodiments, one or more process blocks of FIG. 4 may be performed by enrichment engine 220 of system 130.

At S410, it is determined whether the computed similarity score between the extracted behavior profile and a behavior profile of a known bad actor group is in a category of high similarity or in a category of low similarity. If it is determined that the computed similarity score is in a category of high similarity, execution proceeds with S420. If it determined that computed similarity score is in a category of low similarity, execution proceeds with S430.

At S420, the identity parameters of an identity associated with the extracted behavior profile are added to the behavior profile of the known bad actor group with the highest computed similarity score. In an embodiment, the profile of a known bad actor with the highest similarity score when compared to the extracted behavior profile is identified. Identifying the profile of a known bad actor with the highest score serves to find the profile with which the extracted behavior profile is most appropriately associated. Adding the identity parameters to the behavior profile of the known bad actor group with the highest computed similarity score serves to extend the identities of the behavior profile of the group. Then execution proceeds with S450.

At S430, after it is determined that the similarity score between the extracted behavior profile and a behavior profile of any known bad actor group is in a category of low similarity, a new profile is generated for a new bad actor group. In an embodiment, a new profile group is generated based on the assessment that the extracted attack behavior profile has minimal overlap with the behavior profiles of the known bad actor group to which it is compared. The use of the category of low similarity and the generation of a new profile when an attack behavior profile has a low association with a known bad actor group serves to ensure that new identities associated with attack campaigns are not incorrectly linked to a known bad actor group, and that newly-discovered attack behavior profiles are generated, thus increasing accuracy and efficiency of future detection. In an embodiment, the generation of a new profile is made in the reputation database 150 by the enrichment engine 220 of the system 130.

At S440, the extracted attack behavior profile is associated with the newly-generated profile for the new bad actor group. In an embodiment, identity parameters of an identity associated with the new extracted behavior profile is associated with the new profile group. In an embodiment, the such identity parameters may include IP addresses, subnets, domains, TLS fingerprints, and more.

At S450, an identity-profile score for the identity associated with the extracted behavior profile is set with respect to the known bad actor group. Setting the identity-profile score for the identity associated with the extracted behavior profile involves establishing an initial identity-profile score, which represents how closely related the identity is to the new profile group.

Although FIG. 4 shows example blocks of process S350, in some embodiments, process S350 may include additional blocks, fewer blocks, different blocks, or differently arranged blocks than those depicted in FIG. 4. Additionally, or alternatively, two or more of the blocks of process S350 may be performed in parallel.

FIG. 5 is a flowchart of an example process S350 for enriching the reputation database according to an embodiment. Process S350 is implemented when the attributes associated with an attack campaign are received through the use of a reputation-based detection method. In some embodiments, one or more process blocks of FIG. 5 may be performed by enrichment engine 220 of system 130.

At S510, an identity connected with the extracted attack behavior profile is matched to the behavior profile of an associated bad actor group. The extracted attack behavior profile is matched with the behavior profile of the associated bad actor group based on an initial identity match decision.

At S520, it is determined whether the computed similarity score between the extracted behavior profile and a behavior profile of known bad actor groups is in a category of high similarity, a category of medium similarity, or a category of low similarity. These similarity scores are computed for all known bad actor groups, including the associated bad actor group. If it is determined that the computed similarity score is in a category of high similarity, execution proceeds with S530. If it is determined that the computed similarity score is in a category of medium similarity, execution proceeds with S540. If it is determined that the computed similarity score is in a category of low similarity, execution proceeds with S550.

At S530, an identity-profile score for the identity with respect to the relevant bad actor group is updated. The identity-profile score is defined above.

At S532, a group-profile score for the relevant bad actor group is updated. The group-profile score is defined above. In an embodiment, the group-profile score indicates how defined a group is and the level of confidence in the parameters of the group. For example, if a group has a high group-profile score, then the group is well-defined with high confidence in its parameters. In an embodiment, updating the group-profile with an identity that has a strong similarity score with the group profile serves to strengthen the confidence in the parameters of the group's profile and define the group's profile with more relevant detail. Updating the group-profile score allows for more accurate and efficient detection of attack campaigns associated with the known bad actor group linked with updated group-profile score.

At S534, it is determined whether the high similarity score is computed between the extracted attack behavior profile and the behavior profile of the associated bad actor group. If YES, execution of process S350 ends. If NO, execution proceeds with S536.

At S536, the initial identity match decision made with respect to S510 is shifted. In an embodiment, the initial identity match decision served to match the identity connected with the extracted attack behavior profile to an associated bad actor group connected with a behavior profile. In an embodiment, the fact that the similarity score is between the extracted attack behavior profile and a known bad actor group other than the associated group justifies shifting the initial identity match decision from the associated bad actor group to a another existing bad actor group. After execution of S536, execution of process S350 ends.

At S540, after it is determined that the similarity score between the extracted behavior profile and the associated bad actor group is in a category of medium similarity, the parameters of an identity associated with the extracted behavior profile are added to the behavior profile of the associated bad actor group. Adding the parameters to the behavior profile of the associated bad actor group serves to extend the behavior profile of the associated bad actor group. Updating the behavior profile in this way allows for more accurate and efficient detection of attack campaigns linked to associated bad actor group. It also allows maintaining behavioral profile parameters for existing bad actor groups when the determined similarity score is in a category of a medium similarity e.g., there is a relatively small difference between the two profiles.

At S542, an identity-profile score for the identity associated with extracted attack behavior profile is updated with respect to the associated bad actor group.

At S550, a new profile group is generated. In an embodiment, a new profile group is generated based on the assessment that the extracted profile has a low similarity score with all known bad actor groups. Determining that the similarity score falls in a category of low similarity means there is an insufficient level of similarity to justifying the update of identity-profile scores and group-profile scores, or the addition of parameters to a known bad actor group profile as in the cases where the profile is in a category of medium or high similarity. This guarantees the extracted attack profile is not incorrectly associated with a known bad actor group, ensuring that the profiles of known bad actor groups are not updated with parameters that should not be associated with the profiles.

In an embodiment, the parameters of an identity associated with the extracted behavior profile is associated with the new profile group.

At S552, an identity-profile score for the identity associated with the extracted attack behavior profile is updated with respect to the profile of the new bad actor group.

At S554, a group-profile score between the extracted attack behavior profile and the profile of the new bad actor group is updated.

At S556, the initial identity match decision made with respect to S510 is shifted. In an embodiment, the initial identity match decision served to match the identity connected with the extracted attack behavior profile to an associated bad actor group connected with a behavior profile. In an embodiment, shifting initial identity match decision means that the identity linked to the extracted attack behavior profile is un-matched from the associated bad actor group and re-matched to the new group.

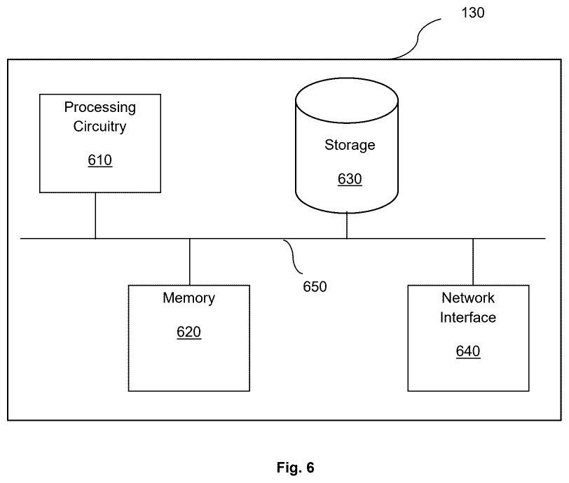

FIG. 6 is an example schematic diagram of a system 130 according to an embodiment. The system 130 includes a processing circuitry 610 coupled to a memory 620, a storage 630, and a network interface 640. In an embodiment, the components of the system 130 may be communicatively connected via a bus 650.

The processing circuitry 610 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 620 may be volatile (e.g., random access memory, etc.), non-volatile (e.g., read only memory, flash memory, etc.), or a combination thereof.

In one configuration, software for implementing one or more embodiments disclosed herein may be stored in the storage 630. In another configuration, the memory 620 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, cause the processing circuitry 610 to perform the various processes described herein.

The storage 630 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 640 allows the detection system 130 to communicate with, for example, the reputation database 150, and the like.

It should be understood that the embodiments described herein are not limited to the specific architecture illustrated in FIG. 6, and other architectures may be equally used without departing from the scope of the disclosed embodiments.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for enriching a reputation database, comprising:
receiving attack attributes associated with an attack campaign;
extracting an attack behavior profile for an identity linked to the attack campaign, wherein the attack behavior profile is based on the received attack attributes;
retrieving, from a reputation database, behavior profiles of known bad actor groups, wherein bad actor groups are collections of network identities identified for engaging in malicious cyber activity;
determining similarity scores between the extracted attack behavior profile and the behavior profiles of each known bad actor group; and
enriching the reputation database by updating, based on the determined similarity scores, the extracted attack behavior profile and the behavior profiles of known bad actor groups stored in the reputation database.

2. The method of claim 1, wherein enriching the reputation database further comprises:
adding behavioral and identity parameters of the extracted attack behavior profile;
generating new group profiles;
de-linking identities with known bad actor groups; and
updating various parameters in the extracted attack behavior profile, the new group profiles, and the behavior profiles of known bad actor groups.

3. The method of claim 1, further comprising:
determining whether each determined similarity score is in a category of high similarity or in a category of low similarity.

4. The method of claim 3, wherein the determined similarity score is in a category of high similarity, further comprising:
adding identity parameters of the identity associated with the extracted attack behavior profile to the behavior profile of a known bad actor group with the highest determined similarity score; and
setting an identity-profile score for the identity associated with the extracted attack behavior profile with respect to the behavior profile of a known bad actor group, wherein the identity-profile score is a measure of how closely an identity matches the behavior profile of a known bad actor group.

5. The method of claim 3, wherein the determined similarity score is in a category of low similarity, further comprising:
generating a new profile group, wherein the new profile group is associated with the identity parameters for the identity associated with the extracted attack behavior profile; and
setting an identity-profile score for the identity associated with the extracted attack behavior profile with respect to the behavior profile of the known bad actor group.

6. The method of claim 1, further comprising:
matching the identity to an associated known bad actor group, wherein the associated known bad actor group is a known bad actor group associated with the identity linked to the attack campaign; and
determining whether each determined similarity score is in a category of high similarity, a category of medium similarity, or a category of low similarity.

7. The method of claim 6, wherein the determined similarity score is in a category of high similarity, further comprising:
updating an identity-profile score for the identity with respect to a behavior profile of a known bad actor group, wherein the identity-profile score is a measure of how closely an identity matches the behavior profile of a group; and
updating a group-profile score for the known bad actor group, wherein the group-profile score is a measurement based on the number of identities in a known bad actor group and the identity-profile score of each identity in the known bad actor group.

8. The method of claim 6, wherein the known bad actor group is a group other than the associated known bad actor group, further comprising:
un-matching the identity to the associated known bad actor group; and
matching the identity to a known bad actor group with the highest calculated similarity score.

9. The method of claim 6, wherein the determined similarity score is in a category of medium similarity, further comprising:
adding identity parameters for the identity associated with the extracted attack behavior profile to the behavior profile of the associated known bad actor group; and
updating an identity-profile score for the identity with respect to the behavior profile of the associated known bad actor group, wherein the identity-profile score is a measure of how closely an identity matches the behavior profile of a group.

10. The method of claim 6, wherein each calculated similarity score is in a category of low similarity, further comprising:
generating a new group profile, wherein the new group profile includes the identity and is stored in the reputation database;
updating an identity-profile score for the identity with respect to the behavior profiles of each known bad actor group, wherein the identity-profile score is a measure of how closely an identity matches the behavior profile of a group;
updating a group-profile score for each known bad actor group, wherein the group-profile score is a measure based on the number of identities in a known bad actor group and the identity-profile score of each identity in the known bad actor group;
un-matching the identity to the associated known bad actor group; and
matching the identity to a known bad actor group with the highest calculated similarity score.

11. The method of claim 1, wherein network identities include network entities, wherein a network entity is any one of: an IP address, a domain name, a URL, an application, or a network device.

12. A non-transitory computer readable medium having stored thereon instructions for causing a processing circuitry to execute a process, the process comprising:
receiving attack attributes associated with an attack campaign;
extracting an attack behavior profile for an identity linked to the attack campaign, wherein the attack behavior profile is based on the received attack attributes;
retrieving, from a reputation database, behavior profiles of known bad actor groups, wherein bad actor groups are collections of network identities identified for engaging in malicious cyber activity;
determining similarity scores between the extracted attack behavior profile and the behavior profiles of each known bad actor group; and
enriching the reputation database by updating, based on the determined similarity scores, the extracted attack behavior profile and the behavior profiles of known bad actor groups stored in the reputation database.

13. A system for detecting botnets, comprising:
a processing circuitry; and
a memory, the memory containing instructions that, when executed by the processing circuitry, configure the system to:
receive attack attributes associated with an attack campaign;
extract an attack behavior profile for an identity linked to the attack campaign, wherein the attack behavior profile is based on the received attack attributes;
retrieve, from a reputation database, behavior profiles of known bad actor groups, wherein bad actor groups are collections of network identities identified for engaging in malicious cyber activity;
determine similarity scores between the extracted attack behavior profile and the behavior profiles of each known bad actor group; and
enrich the reputation database by updating, based on the determined similarity scores, the extracted attack behavior profile and the behavior profiles of known bad actor groups stored in the reputation database.

14. The system of claim 13, wherein the system is further configured to:
add behavioral and identity parameters of the extracted attack behavior profile;
generate new group profiles;
de-link identities with known bad actor groups; and
update various parameters in the extracted attack behavior profile, the new group profiles, and the behavior profiles of known bad actor groups.

15. The system of claim 13, wherein the system is further configured to:
determine whether each determined similarity score is in a category of high similarity or in a category of low similarity.

16. The system of claim 15, wherein the determined similarity score is in a category of high similarity, wherein the system is further configured to:
add identity parameters of the identity associated with the extracted attack behavior profile to the behavior profile of a known bad actor group with the highest determined similarity score; and
set an identity-profile score for the identity associated with the extracted attack behavior profile with respect to the behavior profile of a known bad actor group, wherein the identity-profile score is a measure of how closely an identity matches the behavior profile of a known bad actor group.

17. The system of claim 15, wherein the determined similarity score is in a category of low similarity, wherein the system is further configured to:
generate a new profile group, wherein the new profile group is associated with the identity parameters for the identity associated with the extracted attack behavior profile; and
set an identity-profile score for the identity associated with the extracted attack behavior profile with respect to the behavior profile of the known bad actor group.

18. The system of claim 13, wherein the system is further configured to:
match the identity to an associated known bad actor group, wherein the associated known bad actor group is a known bad actor group associated with the identity linked to the attack campaign; and
determine whether each determined similarity score is in a category of high similarity, a category of medium similarity, or a category of low similarity.

19. The system of claim 13, wherein the determined similarity score is in a category of high similarity, wherein the system is further configured to:
update an identity-profile score for the identity with respect to a behavior profile of a known bad actor group, wherein the identity-profile score is a measure of how closely an identity matches the behavior profile of a group; and
update a group-profile score for the known bad actor group, wherein the group-profile score is a measure based on the number of identities in a known bad actor group and the identity-profile score of each identity in the known bad actor group.

20. The system of claim 13, wherein the known bad actor group is a group other than the associated known bad actor group, wherein the system is further configured to:
un-match the identity to the associated known bad actor group; and
match the identity to a known bad actor group with the highest calculated similarity score.

21. The system of claim 13, wherein the determined similarity score is in a category of medium similarity, wherein the system is further configured to:
add identity parameters for the identity associated with the extracted attack behavior profile to the behavior profile of the associated known bad actor group; and
update an identity-profile score for the identity with respect to the behavior profile of the associated known bad actor group, wherein the identity-profile score is a measure of how closely an identity matches the behavior profile of a group.

22. The system of claim 13, wherein each calculated similarity score is in a category of low similarity, wherein the system is further configured to:
generate a new group profile, wherein the new group profile includes the identity and is stored in the reputation database;
update an identity-profile score for the identity with respect to the behavior profiles of each known bad actor group, wherein the identity-profile score is a measure of how closely an identity matches the behavior profile of a group;
update a group-profile score for each known bad actor group, wherein the group-profile score is a measure based on the number of identities in a known bad actor group and the identity-profile score of each identity in the known bad actor group;
un-match the identity to the associated known bad actor group; and
match the identity to a known bad actor group with the highest calculated similarity score.

23. The system of claim 13, wherein network identities include network entities, wherein a network entity is any one of: an IP address, a domain name, a URL, an application, a network device.
